(19) United States
(12) Patent Application Publication
(10) Pub. No.: US 2021/0285530 A1
(43) Pub. Date: Sep. 16, 2021

(54) HYDRAULIC CONTROL UNIT FOR LIMITED SLIP DIFFERENTIAL

(71) Applicant: Eaton Intelligent Power Limited, Dublin (IE)

(72) Inventors: Matthew G. Fox, Ceresco, MI (US); Jeffrey A. Oesch, Marshall, MI (US); Andrew N. Edler, Homer, MI (US)

(73) Assignee: Eaton Intelligent Power Llimited, Dublin (IE)

(21) Appl. No.: 17/333,081

(22) Filed: May 28, 2021

Related U.S. Application Data
(63) Continuation-in-part of application No. 16/803,381, filed on Feb. 27, 2020, now Pat. No. 11,022,207.
Application No. 16/803,381 is a continuation of application No. PCT/US2018/049210, filed on Aug. 31, 2018.
(60) Provisional application No. 62/553,329, filed on Sep. 1, 2017.

(51) Int. Cl. F16H 48/32; F15B 1/26; F15B 1/02; F15B 11/08; F16H 61/00

(52) U.S. Cl. CPC F16H 48/32; F15B 1/26; F15B 1/02; F16D 25/0638; F16H 61/0021; F16H 61/0009; F15B 11/08

(57) ABSTRACT

A hydraulic control unit that delivers hydraulic fluid to a limited slip differential includes a hydraulic control unit housing having a manifold housing portion and an accumulator housing portion. The accumulator housing portion and manifold housing portion cooperate to form an accumulator chamber that houses the biasing assembly and the piston. A motor is disposed on a first side of the manifold housing portion, and a pump is disposed on a second side of the manifold portion, opposite the first side. The pump is configured to pump fluid into the accumulator chamber of the accumulator housing portion. A reservoir is defined by at least one of the manifold housing portion and the accumulator housing portion, and a bag filter disposed in the reservoir is configured to filter fluid flowing through the reservoir.

### CROSS-REFERENCE TO RELATED APPLICATIONS

This application is a continuation-in-part of U.S. patent Application Ser. No. 16/803,381 filed Feb. 27, 2020, which is a continuation of International Application No. PCT/US2018/049210 filed Aug. 31, 2018, which claims priority to U.S. Provisional Application No. 62/553,329 filed on Sep. 1, 2017. The disclosures of the above applications are incorporated herein by reference thereto.

### FIELD

The present disclosure relates generally to a hydraulic control unit that delivers hydraulic fluid to a limited slip differential and more particularly to a filter for the hydraulic control unit.

### BACKGROUND

Differentials are provided on vehicles to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning to the drive wheel that is not spinning. Electronically-controlled, limited-slip differentials can include a hydraulically-actuated clutch to limit differential rotation between output shafts of the differential. In some configurations a hydraulic delivery device may be located remote from the differential. Hydraulic fluid can get contaminated causing the hydraulically-actuated functions to be diminished and potential eventual failure. Thus, effective filtration of the hydraulic fluid is important to smooth system operation.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one example embodiment, a hydraulic control unit that delivers hydraulic fluid to a limited slip differential is provided. The hydraulic control unit includes a hydraulic control unit housing having a manifold housing portion and an accumulator housing portion. The manifold housing portion defines a fluid pathway arrangement for communicating fluid along at least a first fluid pathway, and the accumulator housing portion houses an accumulator assembly having a biasing assembly and a piston. The accumulator housing portion and manifold housing portion cooperate to form an accumulator chamber that houses the biasing assembly and the piston. A motor is disposed on a first side of the manifold housing portion, and a pump is disposed on a second side of the manifold portion, opposite the first side. The pump is configured to pump fluid into the accumulator chamber of the accumulator housing portion. A reservoir is defined by at least one of the manifold housing portion and the accumulator housing portion, and a bag filter disposed in the reservoir is configured to filter fluid flowing through the reservoir.

In addition to the foregoing, the described hydraulic control unit may include one or more of the following features: wherein the manifold housing portion and the accumulator housing portion cooperate to define the reservoir; wherein the reservoir is a distinct cavity from the accumulator chamber; wherein the accumulator housing portion defines an upstream reservoir portion, and the manifold housing portion defines a downstream reservoir portion; wherein the manifold housing portion includes an end wall with a counterbore formed therein configured to receive at least a portion of the bag filter therein; wherein the bag filter includes a framework supporting a mesh; a seal configured to seal between the framework and the manifold housing portion; and wherein the framework includes a central tubular member coupled to the mesh.

In addition to the foregoing, the described hydraulic control unit may include one or more of the following features: wherein the framework further includes a connecting wall extending radially outward from the central tubular member, the connecting wall configured to be disposed against the manifold housing portion; wherein the framework further includes a perimeter flange coupled to and extending outwardly from the connecting wall, wherein the central tubular member, the connecting wall, and the perimeter flange at least partially define a sediment trap configured to collect sediment contained in the fluid; and wherein the mesh is a 123 micron filter having a surface area of between approximately 1200 mm² and approximately 1400 mm², an open area between approximately 300 mm² and approximately 600 mm², and a resistance to blockage of between approximately 58.0 and approximately 68.0.

In addition to the foregoing, the described hydraulic control unit may include one or more of the following features: wherein the mesh is a 103 micron filter having a surface area of approximately 1299 mm², an open area of approximately 483.4 mm², and a resistance to blockage of approximately 50.9; wherein the biasing assembly further includes a first biasing member having a first spring rate, and a second biasing member having a second spring rate, wherein the first and second spring rates are distinct; wherein the fluid pathway arrangement further defines a second fluid pathway, wherein the first fluid pathway fluidly connects the pump, the accumulator assembly and a valve, wherein the second fluid pathway fluidly connects the pump and the reservoir; and wherein the fluid pathway arrangement is plugged at only two openings defined on the manifold housing portion.

In another example embodiment, a hydraulic control unit that delivers hydraulic fluid to a limited slip differential is provided. The hydraulic control unit includes a hydraulic control unit housing having a manifold housing portion and an accumulator housing portion. The manifold housing portion defines a fluid pathway arrangement for communicating fluid along at least a first fluid pathway, and the accumulator housing portion houses an accumulator assembly having a biasing assembly and a piston. The accumulator housing portion and manifold housing portion cooperate to form an accumulator chamber that houses the biasing assembly and the piston. A motor drives a pump, which pumps fluid into the accumulator chamber of the accumulator housing portion. A reservoir is defined by the manifold housing portion and the accumulator housing portion, the reservoir being distinct from the accumulator chamber. A bag filter is disposed in the reservoir configured to filter fluid flowing through the reservoir.

In addition to the foregoing, the described hydraulic control unit may include one or more of the following features: wherein the bag filter includes a framework supporting a tubular mesh, wherein the framework includes a central tubular member coupled to the tubular mesh; wherein the framework further includes a connecting wall extending radially outward from the central tubular member, the connecting wall configured to be disposed against the manifold housing portion; wherein the framework further includes a perimeter flange coupled to and extending outwardly from the connecting wall, wherein the central tubular member, the connecting wall, and the perimeter flange at least partially define a sediment trap configured to collect sediment contained in the fluid; and wherein the mesh includes a first end coupled to the framework, and a converging opposite second end.

### BRIEF DESCRIPTION OF THE DRAWINGS

The present disclosure will become more fully understood from the detailed description and the accompanying drawings, wherein:

FIG. 1 is a schematic illustration of a limited slip differential, hydraulic control unit and controller according to one example of the present disclosure;

FIG. 2A is rear perspective view of a hydraulic control unit constructed in accordance to one example of the present disclosure;

FIG. 2B is front perspective view of the hydraulic control unit shown in FIG. 2A;

FIG. 3 is a rear perspective view of the hydraulic control unit of FIG. 2B and shown with the pump removed for illustration;

FIG. 4 is a sectional view of an accumulator of the hydraulic control unit taken along lines 4-4 of FIG. 2A;

FIG. 5 is a rear perspective view of the hydraulic control unit of FIG. 2A shown with the accumulator housing and motor removed for illustration;

FIG. 6 is a sectional view of a reservoir of the hydraulic control unit taken along lines 6-6 of FIG. 2A;

FIG. 7 is another sectional view of the hydraulic control unit as shown in FIG. 5 with a filter constructed in accordance to one example of the present teachings shown installed for filtering fluid passing through the reservoir;

FIG. 8 is a sectional view of the hydraulic control unit with a reservoir and filter constructed in accordance to another example of the present teachings; and

FIG. 9 is a sectional view of the hydraulic control unit with a reservoir and filter constructed in accordance to yet another example of the present teachings.

### DETAILED DESCRIPTION

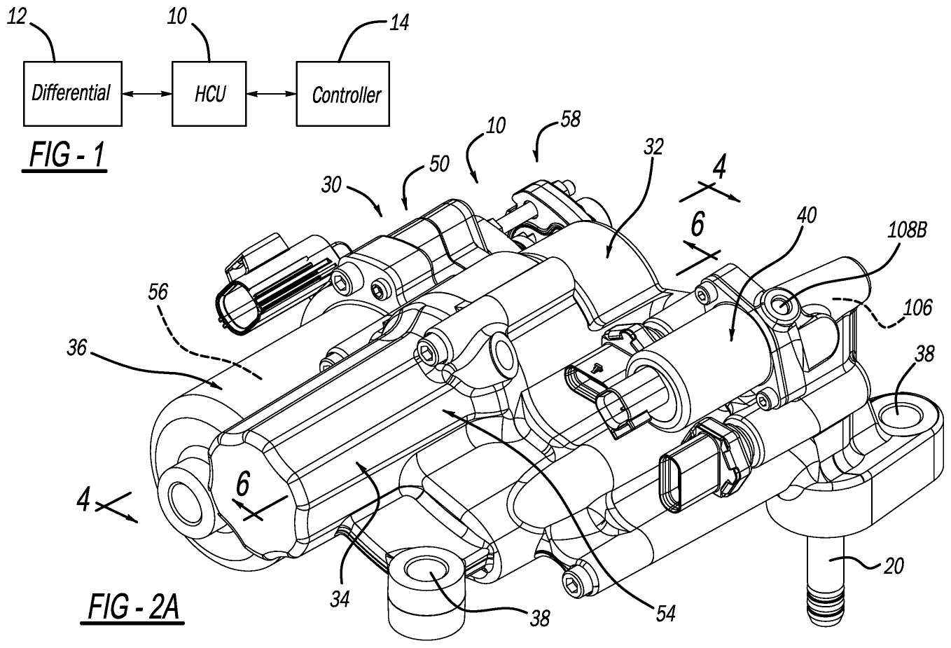

With initial reference to FIG. 1, a hydraulic control unit constructed in accordance to one example of the present disclosure is shown and generally identified with reference numeral 10. As will become appreciated herein, the hydraulic control unit 10 according to the present disclosure provides a single unit that can be mounted against or relative to an axle housing (not specifically shown). In general, the hydraulic control unit 10 can deliver hydraulic fluid to a limited slip differential 12 based on a signal communicated from a controller 14. The limited slip differential 12 can be housed in the axle housing through a hydraulic fluid coupling 20. The limited slip differential 12 can be an electronic limited slip differential having a clutch and a piston (not specifically shown).

The limited slip differential 12 can operate to drive a pair of axle shafts that are connected to a pair of respective drive wheels (not shown). In general, the limited slip differential 12 functions as a traditional open differential during normal operating conditions until an event occurs where a bias torque is required. When a loss in traction is detected or anticipated, the clutch can be selectively actuated in order to generate the optimum bias ratio for the situation.

The limited slip differential 12 can further include a differential gear assembly configured in a differential case that acts to allow the axle shafts to rotate at different speeds. The differential gear assembly 12 can include a pair of side gears (not specifically shown) that are mounted for rotation with the axle shafts (and the drive wheels). In an open configuration, described below, the differential gear assembly 12 acts to allow the axle shafts to rotate at different speeds.

The clutch couples a drive shaft output with the differential gear assembly 12. The clutch can include a clutch pack (not specifically shown) that has a plurality of annular plates interleaved between a plurality of annular friction disks. The plurality of annular plates and annular friction disks are interleaved between one another and act to rotate past one another in substantially non-contacting relationship when the clutch is in its open position. However, it will be appreciated by those skilled in the art that the term “non-contacting” as used herein is relative and is not meant to necessarily indicate that the annular plates and annular friction disks have absolutely no contact when the clutch is in the open condition. The annular plates and annular friction disks are axially movable into frictional engagement relative to one another, thereby reducing relative rotation between the annular plates and annular friction disks when the clutch is in the closed or partially closed configurations. In this manner, when the clutch is in its closed position, the side gears, as well as the axle shafts and the drive wheels rotate together.

The clutch can operate in an open configuration to allow the side gears to rotate independently from each other, e.g., at different speeds. The clutch can also operate in a closed or partially closed configuration where the side gears rotate together or partially together (that is, not independently), e.g., at substantially the same speed. The clutch is a hydraulic clutch that utilizes pressurized hydraulic fluid provided through the hydraulic fluid coupling 20 from the hydraulic control unit 10 to act on the piston to selectively actuate the clutch pack between the open, closed and partially closed configurations. It will be appreciated that the limited slip differential 12 described above is merely exemplary. In this regard, the hydraulic control unit 10 can be used to deliver hydraulic fluid to an actuator (piston, etc.) of any limited slip differential configuration.

With general reference now to FIGS. 1-4, the hydraulic control unit 10 will be described in greater detail. The hydraulic control unit 10 can generally include a hydraulic control unit housing 30 having a manifold housing portion 32, an accumulator housing portion 34 and a motor housing portion 36. The hydraulic control unit housing 30 defines a plurality of mounting bores 38 for receiving fasteners when bolting the hydraulic control unit 10 onto an axle housing. A solenoid valve 40 is provided on the hydraulic control unit 10. In general, the solenoid valve 40 opens and closes to allow hydraulic fluid to communicate with the limited slip differential 12.

The hydraulic control unit 10 includes a pump assembly 50 and an accumulator assembly 54. The pump assembly 50 has a motor 56, a pump 58. According to the present disclosure, the motor 56 and the pump 58 are disposed on opposite sides of the manifold housing portion 32. Specifically, the motor 56 is disposed on a first side 60 of the manifold housing portion 32 while the pump 58 is disposed on a second side 62 of the manifold housing portion 32. The arrangement provides an efficient arrangement for pumping fluid through the manifold housing portion 32 as will be described herein.

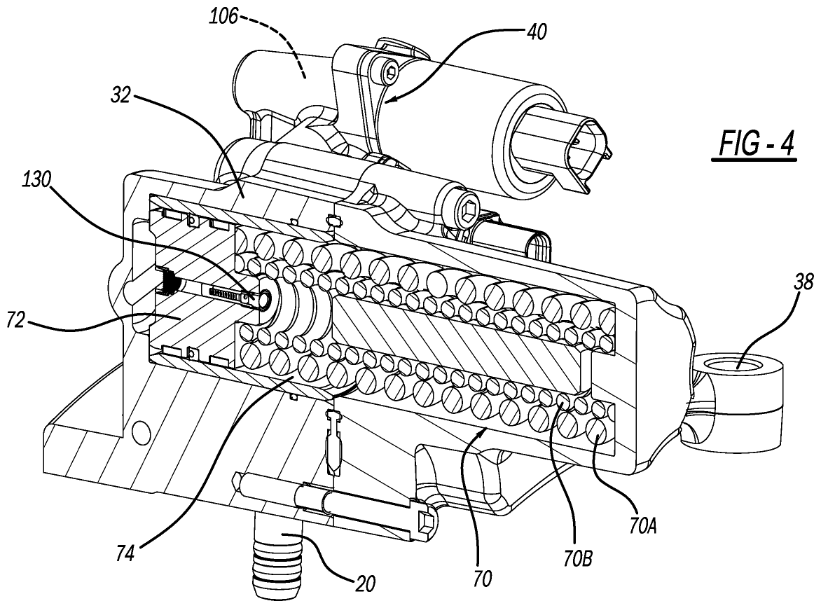

The accumulator assembly 54 includes a biasing assembly 70 and a piston 72 received within an accumulator chamber 74 (FIG. 4). The biasing assembly 70 includes first and second biasing members 70A and 70B. The first biasing member 70A has a first spring rate while the second biasing member 70B has a second spring rate. The first and second spring rates cooperate together to provide a desired spring rate for the biasing assembly 70. As will become appreciated herein, fluid is pumped behind the piston 72 into the accumulator chamber 74 to cause the piston 72 to translate toward the first and second biasing members 70A, 70B. As can be appreciated, fluid is pressurized when in the accumulator chamber on an opposite side of the piston 72 as the biasing assembly 70.

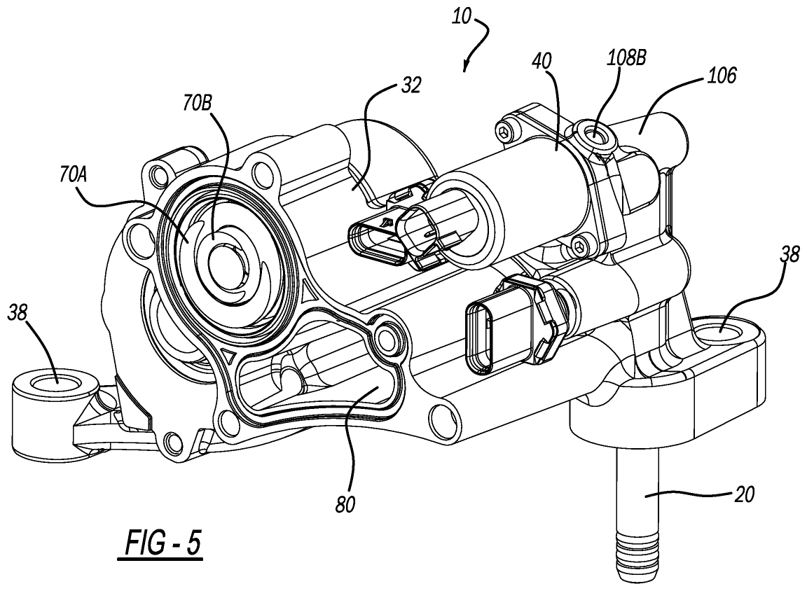

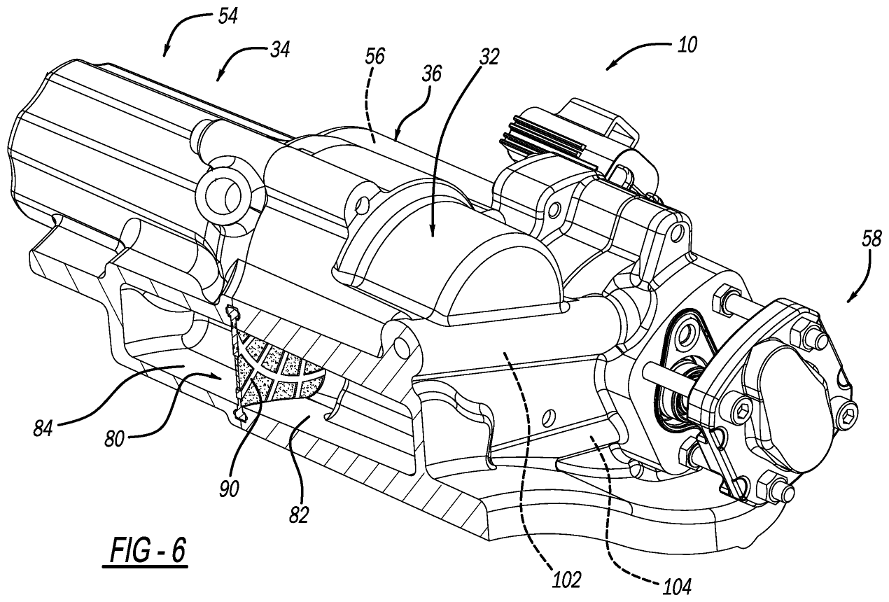

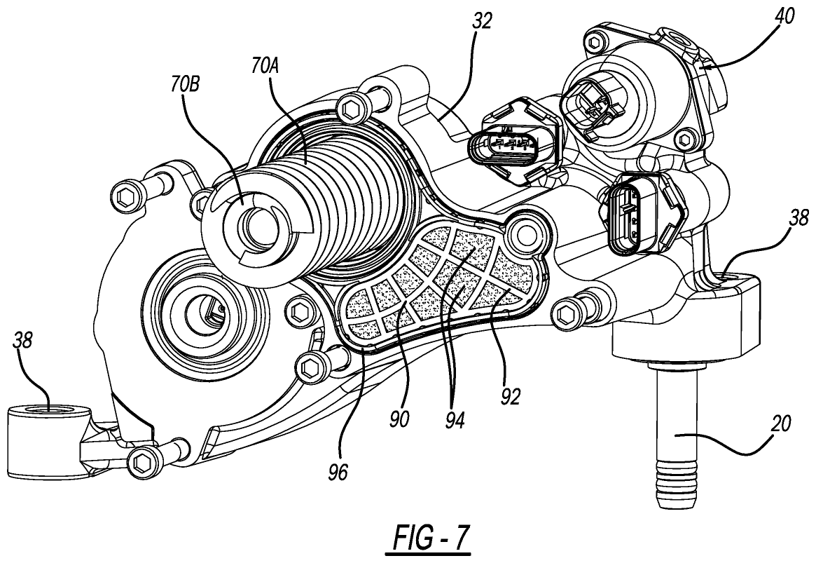

Referring now to FIGS. 5-7, the manifold housing portion 32 and the accumulator housing portion 34 cooperate to define a reservoir 80. The reservoir 80 is vented to atmosphere. The reservoir 80 is a distinct cavity from the accumulator assembly 54 and can be located generally under the accumulator assembly 54. By moving the reservoir away from the accumulator chamber 74, debris and contamination that may be generated by the biasing assembly 70 can be better managed. In particular, the manifold housing portion 32 defines an upstream reservoir portion 82 and the accumulator housing portion 34 defines a downstream reservoir portion 84. A filter 88 is disposed between the manifold housing portion 32 and the accumulator housing portion 34. The filter 88 filters hydraulic fluid as it passes from the upstream reservoir portion 82 to the downstream reservoir portion 84. The filter 88 includes a framework 92 that supports a mesh 94. A seal 96 can be over-molded or otherwise formed around a perimeter of the framework 92 and operates as a seal between the manifold housing portion 32 and the accumulator housing portion 34 in an assembled position. The filter 88 provides significant flow area for optimally filtering hydraulic fluid while minimizing flow rate loss.

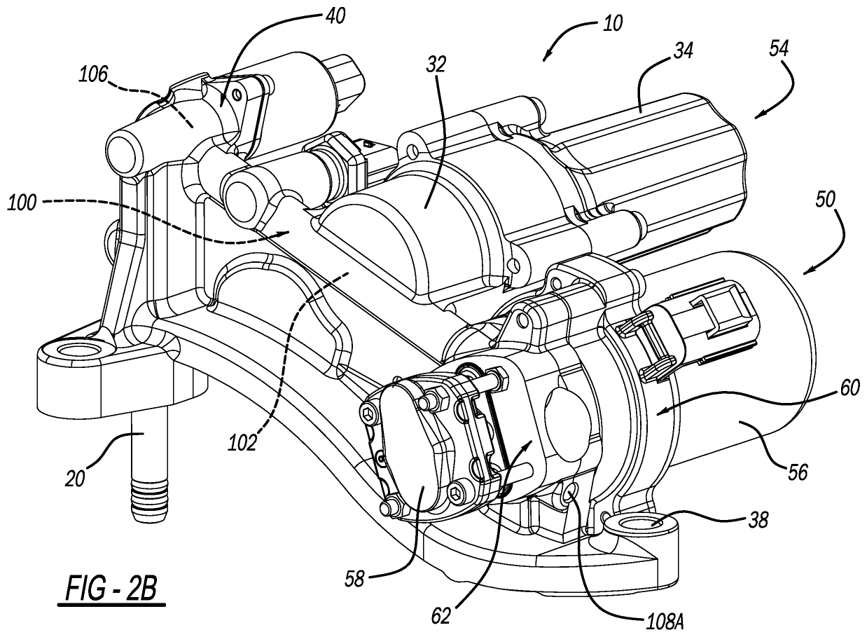

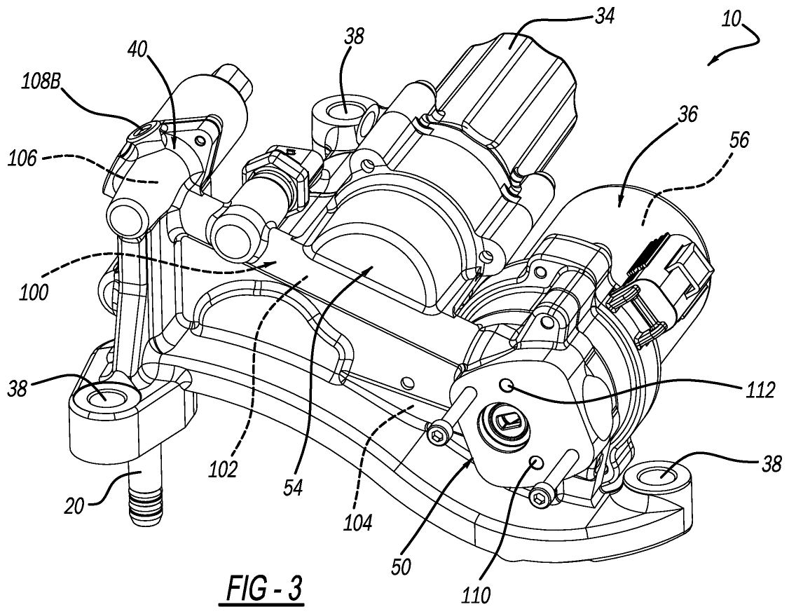

With particular reference now to FIGS. 2B and 3, the manifold housing portion 32 will now be described in greater detail. As will become appreciated, the manifold housing portion 32 provides minimal fluid paths with minimal changes in direction to reduce reaction time and simplify manufacturing. In this regard, the manifold portion 32 defines a fluid pathway arrangement 100 having a first fluid pathway 102 and a second fluid pathway 104. The manifold portion 32 further defines a dump chamber 106 where fluid returning from the differential assembly 12 is routed back to the reservoir 80. The first fluid pathway 102 fluidly connects the solenoid valve 40, the accumulator assembly 54 and the pump assembly 50. The second fluid pathway 104 fluidly connects the pump assembly 50 to the reservoir 80. The fluid pathway is simplified and requires plugging openings in the manifold housing portion 32 only at low-pressure locations. As viewed in FIG. 2B, a first ball 108A is shown plugging a first opening and in FIGS. 3 and 5, a second ball 108B is shown plugging a second opening.

During operation, low-pressure fluid flows from the reservoir through the second fluid pathway 104. Fluid exits a low-pressure port 110 (FIG. 3) and is pumped by the pump 58 out of a high-pressure port 112 and to the accumulator assembly 54 through the first fluid pathway 102. The accumulator assembly 54 is said to be “charged” when fluid causes the piston 72 to stroke. When fluid is requested to be delivered to the limited slip differential 12, the valve 40 is opened and the piston 72 is caused to stroke in a direction leftward as viewed in FIG. 4 upon urging from the biasing assembly 70. High pressure hydraulic fluid leaves the accumulator chamber 72, flows along the first fluid pathway from the accumulator chamber 72 to the valve 40 and out through the hydraulic fluid coupling 20 to the clutch of the limited slip differential 12. Notably only one change of direction is generally required for the fluid to undergo at the valve 40. Additionally, the valve 40 is positioned generally adjacent to or above the hydraulic fluid coupling 20 reducing necessary distance to communicate hydraulic fluid from the accumulator assembly 54 and out of the hydraulic fluid coupling 20.

The hydraulic control unit 10 can further include a clutch piston pressure sensor, an accumulator pressure sensor and a three-way proportional regulating valve. The clutch piston pressure sensor can be threadably or otherwise securely received by the hydraulic control unit housing 30. The clutch piston pressure sensor can be configured to measure a pressure at the piston of the limited slip differential. The accumulator pressure sensor can be threadably or otherwise securely received by the hydraulic control unit housing 30. The accumulator pressure sensor can be configured to measure a pressure in the accumulator chamber 74. The three-way proportional regulating valve can be securely coupled to the hydraulic control unit housing 30. The three-way proportional regulating valve can be configured to regulate fluid pressure within the unitary hydraulic control unit housing 30.

The motor 56 can operate the pump 58 and can be conventionally constructed. The pump 58 is a bolt-on gear pump that is bolted onto the manifold housing portion 32. The pump 58 can cause a pumping action on the fluid contained in the reservoir 80 of the hydraulic control unit housing 50. The pumping action ultimately causes the fluid to be pumped into the accumulator chamber 74. In doing so, the biasing members 70A, 70B at least partially collapse and introduces a pre-charge into the system. In this regard, the motor 56 is not required to run constantly. The fluid pressure can be introduced into the limited slip differential 12 by the biasing members 70A, 70B acting on the piston 72 when the solenoid valve 40 is opened (by a signal sent from the controller 14). A pressure relief valve 130 can be provided in the piston 72. The pressure relief valve 130 can protect the system by releasing fluid in the event of an over pressure malfunction.

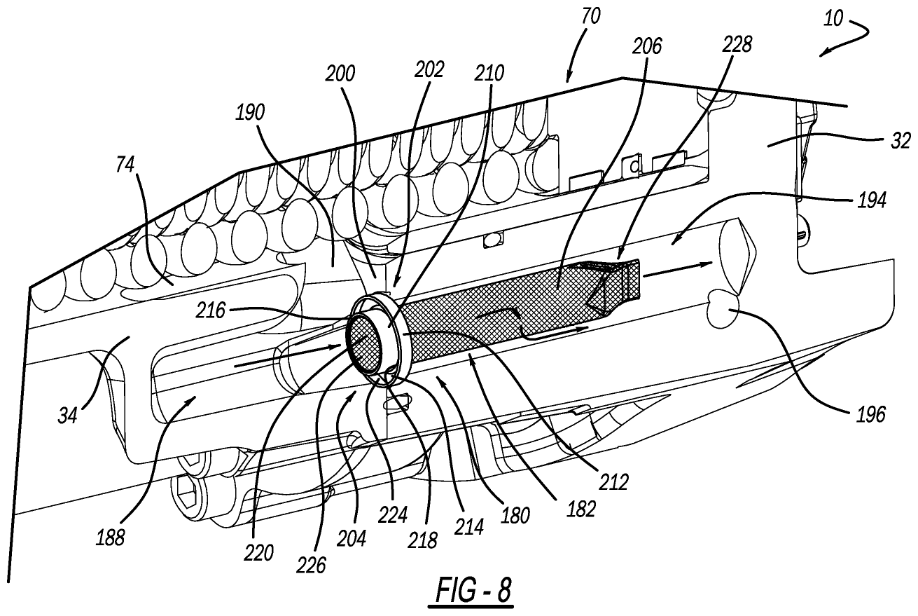

Referring now to FIG. 8, hydraulic control unit 10 is illustrated with an alternative reservoir 180 instead of reservoir 80, and like reference numerals identify like parts. In the example alternative embodiment, reservoir 180 is similar to reservoir 80 except it includes a filter 182 disposed between manifold housing portion 32 and accumulator housing portion 34. In particular, the accumulator housing portion 34 defines an upstream reservoir portion 188 with an inlet 190 connected to the accumulator chamber 74, and the manifold housing portion 32 defines a downstream reservoir portion 194 with an outlet 196 fluidly coupled to, for example, the second fluid pathway 104 and pump 58. The upstream and downstream reservoir portions 188, 194 are separated by an end wall 200 of the manifold housing portion 32, which includes a counterbore 202 configured to receive at least a portion of the filter 182 therein.

In the example embodiment, the filter 182 is configured to filter hydraulic fluid as it passes from the upstream reservoir portion 188 to the downstream reservoir portion 194. In the illustrated example, the filter 182 generally includes a framework 204 that supports a mesh 206 and an optional seal 208. As shown, the framework 204 includes a central tubular member 210, an outer ring or perimeter flange 212, and a connecting wall 214 extending therebetween. The central tubular member 210 is generally annular and defines a first end 216, an opposite second end 218, and a fluid passage 220 therein. The connecting wall 214 is coupled to and extends radially outward from the tubular member second end 218. As shown in FIG. 8, the connecting wall 214 is configured to abut against a shoulder 222 defined by the counterbore 202. The perimeter flange 212 is coupled to and extends outwardly from the connecting wall 214 in an orientation parallel to or substantially parallel to the central tubular member 210, and perpendicular to or substantially perpendicular to the connecting wall 214. In this way, the central tubular member 210, the perimeter flange 212, and the connecting wall 214 at least partially define a cavity or sediment trap 224 configured to trap or collect sediment contained in the hydraulic fluid as is passes into the filter 182.

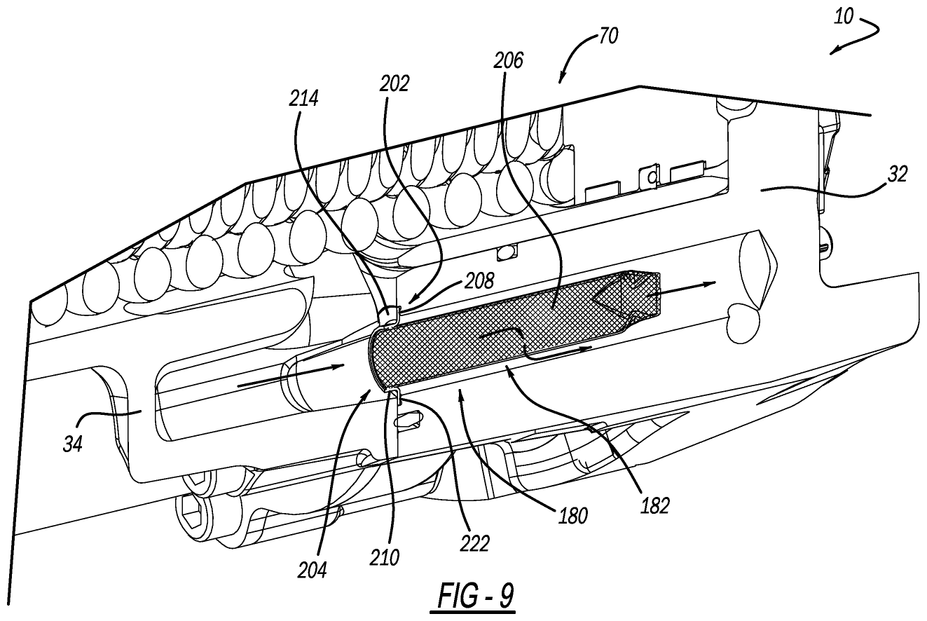

In an alternative configuration, FIG. 9 illustrates filter 182 in section where framework 204 only includes the central tubular member 210 and the radially outward extending wall 214 (without the perimeter flange 212). In the example embodiment, the outwardly extending wall 214 is configured to seat within counterbore 202, which is smaller than that depicted in FIG. 8 since it does not accommodate the absent perimeter flange 212. If utilized in either of the FIG. 8 or 9 embodiments, the seal 208 can be over-molded or otherwise coupled to the perimeter flange 212 and/or wall 214 for sealing against one or more portions of the counterbore 202.

In the example embodiment, the mesh 206 is a filter-like material configured to filter the hydraulic fluid of debris and contamination that may be generated by the biasing assembly 70. As illustrated, the mesh 206 is a bag filter having a generally tubular shape and includes a first end 226 and an opposite second end 228. The first end 226 is coupled to an inner diameter surface of the central tubular member 210, and the generally free second end 228 is disposed within the downstream reservoir portion 194. In the example implementation, the mesh 206 has a constant or substantially constant diameter as it extends from the first end 226 toward the second 228. However, in some configurations, like that shown in FIGS. 8 and 9, portions of the second end 226 may converge.

During one example operation of the hydraulic control unit 10, hydraulic fluid flows from the upstream reservoir portion 188 to the inlet of filter 182, which is disposed within the counterbore 202 formed in the manifold housing 32. As the hydraulic fluid enters the filter 182, larger contaminants are trapped in the sediment trap 224 while smaller contaminants are trapped as the fluid passes through the filter mesh medium 206. In the example embodiment, the reservoir 180 and filter 182 configuration described herein are configured to provide various benefits over single screen filters, which often require additional machining operations due to a recessed offset hole needed for a screen type filter to be installed properly with a tight seal. Advantageously, the present reservoir 180 and filter 182 configuration only requires one machine operation (e.g., forming reservoir portion 194) without a recessed offset hole. Additionally, the filter mesh 206 has a larger surface area relative to single screen filters, thereby providing increased flow area, less flow restriction, and increased surface area allowing for a higher resistance to blockage (ROB).

In one example embodiment, the filter 182 is a 123 Micron filter having a surface area of between approximately 1200 mm² and approximately 1400 mm², or between 1200 mm² and 1400 mm². In another example, the surface area is 1299 mm² or approximately 1299 mm². In one example, filter 182 can include an open area between approximately 300 mm² and approximately 600 mm², or between 300 mm² and 600 mm². In another example, the open area is 437 mm² or approximately 437 mm². In one example, filter 182 can have a ROB of approximately 58.0 and approximately 68.0, or between 58.0 and 68.0. In another example, the ROB is 63.3 or approximately 63.3.

In yet another example embodiment, filter 182 is a 103 Micron filter having a surface area of between approximately 1200 mm² and approximately 1400 mm², or between 1200 mm² and 1400 mm². In another example, the surface area is 1299 mm² or approximately 1299 mm². In one example, the filter 182 can include an open area between approximately 350 mm² and approximately 650 mm², or between 350 mm² and 650 mm². In another example, the open area is 483.4 mm² or approximately 483.4 mm². In one example, filter 182 can have a ROB between approximately 40 and approximately 60, or between 40 and 60. In another example, the ROB number is 50.9 or approximately 50.9.

The foregoing description of the examples has been provided for purposes of illustration and description. It is not intended to be exhaustive or to limit the disclosure.

Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A hydraulic control unit that delivers hydraulic fluid to a limited slip differential, the hydraulic control unit comprising:
a hydraulic control unit housing having a manifold housing portion and an accumulator housing portion, wherein the manifold housing portion defines a fluid pathway arrangement for communicating fluid along at least a first fluid pathway, wherein the accumulator housing portion houses an accumulator assembly having a biasing assembly and a piston, the accumulator housing portion and manifold housing portion cooperating to form an accumulator chamber that houses the biasing assembly and the piston;
a motor disposed on a first side of the manifold housing portion;
a pump disposed on a second side of the manifold portion, opposite the first side, wherein the pump is configured to pump fluid into the accumulator chamber of the accumulator housing portion;
a reservoir defined by at least one of the manifold housing portion and the accumulator housing portion;
a bag filter disposed in the reservoir and configured to filter fluid flowing through the reservoir.

2. The hydraulic control unit of claim 1, wherein the manifold housing portion and the accumulator housing portion cooperate to define the reservoir.

3. The hydraulic control unit of claim 2, wherein the reservoir is a distinct cavity from the accumulator chamber.

4. The hydraulic control unit of claim 2, wherein the accumulator housing portion defines an upstream reservoir portion, and the manifold housing portion defines a downstream reservoir portion.

5. The hydraulic control unit of claim 4, wherein the manifold housing portion includes an end wall with a counterbore formed therein configured to receive at least a portion of the bag filter therein.

6. The hydraulic control unit of claim 1, wherein the bag filter includes a framework supporting a mesh.

7. The hydraulic control unit of claim 6, further comprising a seal configured to seal between the framework and the manifold housing portion.

8. The hydraulic control unit of claim 6, wherein the framework includes a central tubular member coupled to the mesh.

9. The hydraulic control unit of claim 8, wherein the framework further includes a connecting wall extending radially outward from the central tubular member, the connecting wall configured to be disposed against the manifold housing portion.

10. The hydraulic control unit of claim 9, wherein the framework further includes a perimeter flange coupled to and extending outwardly from the connecting wall,
wherein the central tubular member, the connecting wall, and the perimeter flange at least partially define a sediment trap configured to collect sediment contained in the fluid.

11. The hydraulic control unit of claim 9, wherein the mesh is a 123 micron filter having:
a surface area of between approximately 1200 mm² and approximately 1400 mm²;
an open area between approximately 300 mm² and approximately 600 mm²; and
a resistance to blockage of between approximately 58.0 and approximately 68.0.

12. The hydraulic control unit of claim 9, wherein the mesh is a 103 micron filter having:
a surface area of approximately 1299 mm²;
an open area of approximately 483.4 mm²; and
a resistance to blockage of approximately 50.9.

13. The hydraulic control unit of claim 1, wherein the biasing assembly further comprises:
a first biasing member having a first spring rate; and
a second biasing member having a second spring rate, wherein the first and second spring rates are distinct.

14. The hydraulic control unit of claim 1, wherein the fluid pathway arrangement further defines a second fluid pathway, wherein the first fluid pathway fluidly connects the pump, the accumulator assembly and a valve, wherein the second fluid pathway fluidly connects the pump and the reservoir.

15. The hydraulic control unit of claim 1, wherein the fluid pathway arrangement is plugged at only two openings defined on the manifold housing portion.

16. A hydraulic control unit that delivers hydraulic fluid to a limited slip differential, the hydraulic control unit comprising:
a hydraulic control unit housing having a manifold housing portion and an accumulator housing portion, wherein the manifold housing portion defines a fluid pathway arrangement for communicating fluid along at least a first fluid pathway, wherein the accumulator housing portion houses an accumulator assembly having a biasing assembly and a piston, the accumulator housing portion and manifold housing portion cooperating to form an accumulator chamber that houses the biasing assembly and the piston;
a motor that drives a pump, wherein the pump pumps fluid into the accumulator chamber of the accumulator housing portion;
a reservoir defined by the manifold housing portion and the accumulator housing portion, the reservoir being distinct from the accumulator chamber; and
a bag filter disposed in the reservoir and configured to filter fluid flowing through the reservoir.

17. The hydraulic control unit of claim 16, wherein the bag filter includes a framework supporting a tubular mesh, wherein the framework includes a central tubular member coupled to the tubular mesh.

18. The hydraulic control unit of claim 17, wherein the framework further includes a connecting wall extending radially outward from the central tubular member, the connecting wall configured to be disposed against the manifold housing portion.

19. The hydraulic control unit of claim 18, wherein the framework further includes a perimeter flange coupled to and extending outwardly from the connecting wall,
wherein the central tubular member, the connecting wall, and the perimeter flange at least partially define a sediment trap configured to collect sediment contained in the fluid.

20. The hydraulic control unit of claim 17, wherein the mesh includes a first end coupled to the framework, and a converging opposite second end.
